(19) United States
(12) Patent Application Publication
(10) Pub. No.: US 2003/0025715 A1
(43) Pub. Date: Feb. 6, 2003

(54) Method and apparatus for generating input events

(75) Inventors: Jon E. Graham, San Jose, CA (US); Hidetoshi Mori, Yamato-shi (JP); Arimasa Naitoh, Gujisawa-shi (JP); David Sawin, Durham, NC (US)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY (US)

(21) Appl. No.: 10/184,205

(22) Filed: Jun. 28, 2002

(30) Foreign Application Priority Data
Jul. 18, 2001 (JP) 2001-218462

(51) Int. Cl. G09G 5/00

(52) U.S. Cl. 345/660

(57) ABSTRACT

A method and apparatus for generating an input event that allows a user to easily and correctly select a small object on a display screen is provided for. An input event generating method and apparatus, according to the present invention, includes a method of generating an input event in an image display system having a display device and a pointing device for pointing an image displayed on the display screen of the display device with a pointer. There are included therein the steps of: displaying a zoom window for zooming a given area in a display screen in response to a process-initiating action in displaying the screen; and, when a manipulation of the pointing device is detected at first coordinates in the zoom window, generating an input event corresponding to the pointing device manipulation at second coordinates associated with the first coordinates in the given area.

### BACKGROUND OF THE INVENTION

1. The Field of the Invention

The present invention relates to a screen display on a display device of an information terminal, such as a personal computer, for example, and more particularly, to a method and apparatus of generating an input event that allows a user to easily and correctly select a small object on the screen.

2. Background of the Art

It can be difficult to select a small object with a mouse pointer on a screen of a display for an information terminal, such as a personal computer, for example. Especially, if the object to be selected is very small, a user must often look closely at the screen in order to correctly place the mouse pointer on the object. Furthermore, the higher the resolution of the display, the more difficult it often is to select such an object therein.

There are known to be many methods of solving the problem with the selection of an object using a mouse pointer. For example, the object to be selected may be enlarged by reducing the resolution of the display. To reduce the resolution, however, a number of extra steps are required, such as, selecting a screen property then selecting a “setting” tab page then selecting a resolution then pressing the “OK” button. In addition, these steps typically need to be performed repeatedly to restore the display to its original resolution after the object is selected, making this method impractical and time-consuming. Further, and unfortunately, changing the resolution of the display may also change the layout of windows on the screen.

Another attempted approach may include the use of a magnifier provided by Windows (registered trademark of Microsoft Corporation). The magnifier creates a fixed window occupying a portion of a screen, in which an enlarged image of an area around the mouse pointer is displayed. However, the user must constantly move a focus between the mouse pointer and the window of the magnifier during manipulating an object because the magnifier window is displayed independently of the position of the mouse pointer. In addition, the user must manually close the magnifier because, once activated, as it resides in a working area on the screen and does not automatically close.

The applicant of the present invention has proposed in Published Unexamined Japanese Patent Application No. 2000-322169 a hotspot selecting method in a graphical user interface that allows a target hotspot to be selected is accurately selected. However, this method is only effective for a predefined hotspot and is different from a dot-by-dot (coordinate-by-coordinate) manipulation according to the present invention. That is, this method cannot be applied when a particular dot on a canvas is painted in an application such as a painting program.

### SUMMARY OF THE INVENTION

It is therefore an object of the present invention to solve the above-mentioned problems and provide a method and apparatus of generating an input event that allows a user to easily and correctly select a small object on a display screen.

The input event generating method according to the present invention is a method of generating an input event in an image display system comprising a display device and a pointing device for pointing an image displayed on the display screen of the display device with a pointer. The method comprises the steps of: displaying a zoom window for zooming a given area in a display screen in response to a process-initiating action when displaying a screen display; and, when an operation of the pointing device is detected at first coordinates in the zoom window, generating an input event corresponding to the pointing device operation at second coordinates corresponding to the first coordinates in the given area.

The information terminal apparatus according to the present invention provides an apparatus and the above-describe input event generation method.

The term “pointing device” herein refers to a device for identifying coordinates on a display screen, including a mouse, TrackPoint (registered trademark of IBM Corp.), trackball, joystick, or the like.

Preferred embodiments include configurations wherein: a process-initiating action is defined by pressing a zoom button assigned to a particular button or key; the given area is a rectangular area around the position of the mouse pointer at which a process-initiating action is detected; the zoom window is closed after no operation is performed on the zoom window for a predetermined time period; the zoom window is closed when the zoom button is pressed while the zoom window is displayed; the zoom window is moved by an operation for moving the mouse pointer while pressing the zoom button; and the scaling factor of the zoom window can be changed. In addition, the shape of the zoom window may be changed by using a well-known window shape changing method (for example, dragging a corner of the window or the middle of the boundary of the window to change the shape of the window into a desired rectangle).

According to the present invention, a magnified image of an area around a mouse pointer is displayed in the position where the mouse pointer is placed when a zoom button is pressed, thereby allowing a user to easily and correctly select a small object on display screen with the mouse pointer. In addition, a zoom window is used to zoom up a required minimum area without changing the placement of windows, thereby allowing a more seamless operation. Furthermore, because a coordinate-by-coordinate manipulation can be performed, each individual pixel on the zoom window can be selected with the mouse pointer to paint it, for example.

### BRIEF DESCRIPTION OF THE DRAWINGS

Other aspects, features, and advantages of the present invention will become more fully apparent from the following detailed description, the appended claims, and the accompanying drawings in which:

FIG. 1 is a drawing depicting one example of an input event generating method according to the present invention;

FIG. 2 is a drawing depicting one example of an input event generating method according to the present invention in conjunction with FIG. 1;

FIG. 3 is a drawing depicting one example of an input event generating method according to the present invention in conjunction with FIG. 1;

FIG. 4 is a flowchart illustrating one example of the input event generating method according to the present invention;

FIG. 5 is a flowchart illustrating one example of the input event generating method according to the present invention in conjunction with FIG. 4;

FIG. 6 is a flowchart illustrating a select portion of FIGS. 4 and 5;

FIG. 7 is a flowchart illustrating a select portion of FIGS. 4 and 5;

FIG. 8 is a flowchart illustrating a select portion of FIGS. 4 and 5;

FIG. 9 is a block diagram showing a flow of click data when no zoom window is activated;

FIG. 10 is a block diagram of a flow of click data in the input event generating method according to the present invention; and,

FIG. 11 is a diagram depicting a specific example of operations in a zoom method according to the present invention.

### DETAILED DESCRIPTION OF THE PREFERRED EMBODIMENTS

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings.

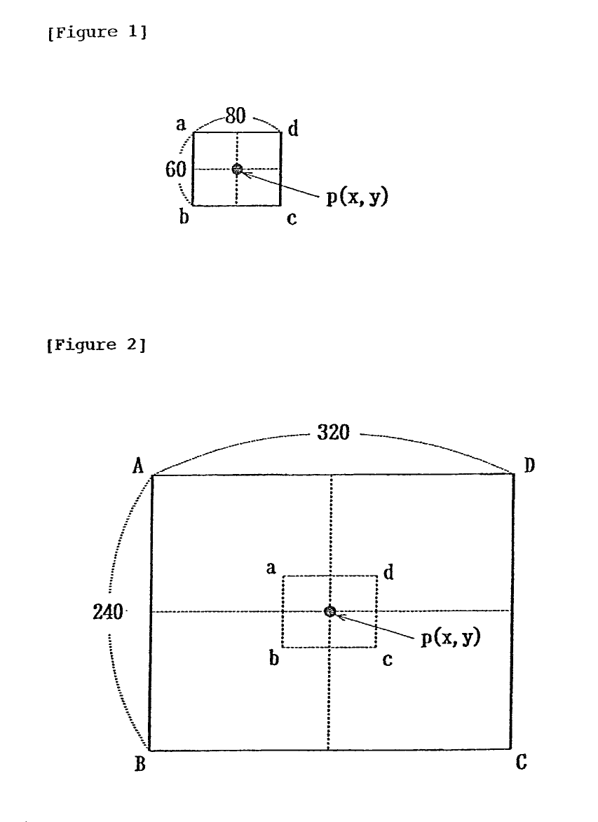

FIGS. 1 through 3 are diagrams of an example of a method of generating an input event according to the present invention, showing a position on the screen of a display. Referencing FIGS. 1 through 3, a method of displaying a zoom window on the screen, which is included in the input event generating method of the present invention, will be mainly described below.

When the center button of a TrackPoint of ThinkPad (registered trademark of IBM Corporation), for example, is pressed as a zoom-process-initiating action, the coordinates of a mouse pointer is obtained and an image in a 80×60-dot area around the coordinates is captured, as shown in FIG. 1. In the example shown in FIG. 1, p (x, y) indicates the position of the mouse pointer and a, b, c, and d indicate coordinates a (x−40, y−30), b (x−40, y+29), c (x+39, y+29), and d (x+39, y−30), respectively.

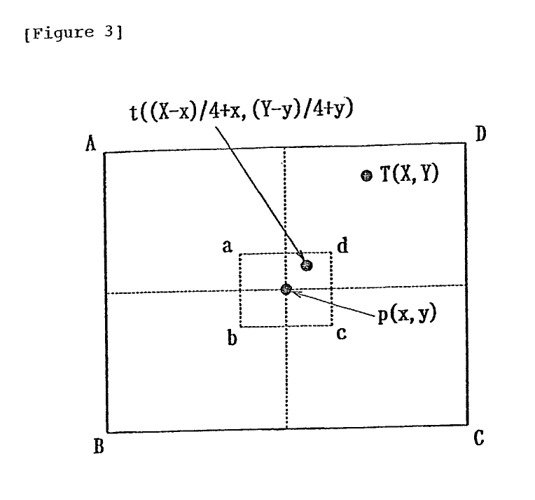

Then, a 320 240 dot zoom window is created around the mouse pointer position p (x, y), as shown in FIG. 2. In the example shown in FIG. 2, A, B, C, and D indicate coordinates A (x−160, y−120), B (x−160, y+119), C (x+159, y+119), and D(x+159, y−120), respectively. Then the captured 80×60-dot image is enlarged by a factor of 16 and displayed in the 320×240 dot zoom window created. Thus, vertices a, b, c, and d in FIG. 1 correspond to A, B, C, and D, respectively.

When an input is performed with a mouse click on point T (X, Y) within the zoom window as shown in FIG. 3, the method waits for the next mouse click for a period slightly longer than an amount of time defined as a double-click interval. If another mouse click input is performed on point T (X, Y) in the zoom window, the zoom window is closed and double-click data is sent to point t ((X−x)/4+x, (Y−y)/4+y). If no other click input is performed on point T, the zoom window is closed and single-click data is sent to point t ((X−x)/4+x, (Y−y)/4+y).

While the 80×60 dot area around the mouse pointer is captured and magnified by a factor of 16 in this example, the zoom window can be changed into a rectangle of any desired size by dragging it. In addition, a desired scaling factor can be set to display a zoom window most easily manageable by a user. In such a case, the area captured would be a rectangle defined by coordinates a (x−W/2, y−H/2), b (x−W/2, y+H/2−1), c (x+W/2−1, y+H/2−1), and d (x+W/2−1, y−H/2) and the zoom window would be a rectangle defined by coordinates A (x−nW/2, y−nH/2), B (x−nW/2, y+nH/2−1), C (x+nW/2−1, y+nH/2−1), and D (x+nW/2−1, y−nH/2), where H represents the height, W represents the width, and n×n represents the scaling factor of the area. A rectangular image captured would be magnified by a factor of n×n and displayed in this rectangle. The coordinates of point t is ((X−x)/n+x, (Y−y)/n+y).

If no manipulation is performed on the zoom window for 15 seconds, for example, the zoom window is closed.

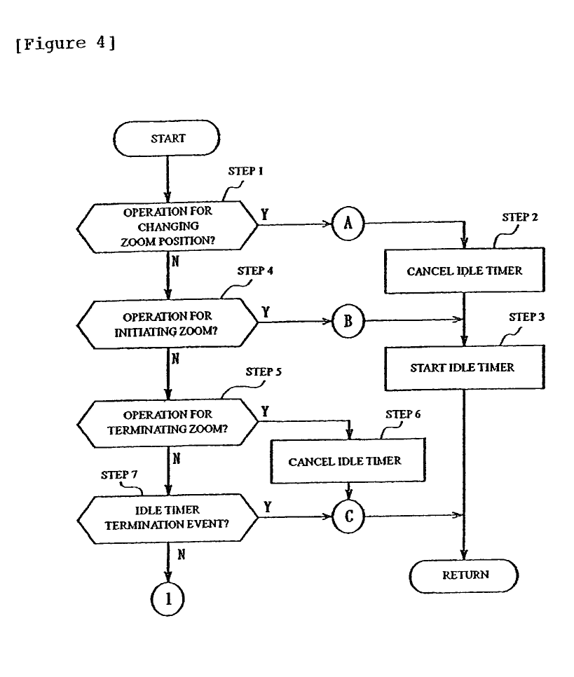

FIGS. 4 through 8 are flowcharts illustrating an example of the input event generating method according to the present invention. Operations on a zoom window, which are included in the input event generating method of the present invention, will be detailed below with reference to the flowcharts shown in FIGS. 4 through 8. Some of the following description will be the repetition of the forgoing description of FIGS. 1 through 3. In the flowcharts shown in FIGS. 4 through 8, it is assumed that the click timer set time is a double-click interval defined by an operating system. The idle timer represents a time interval during which no operation is performed on the zoom window. In this example, assumption is that the idle time is 15 seconds.

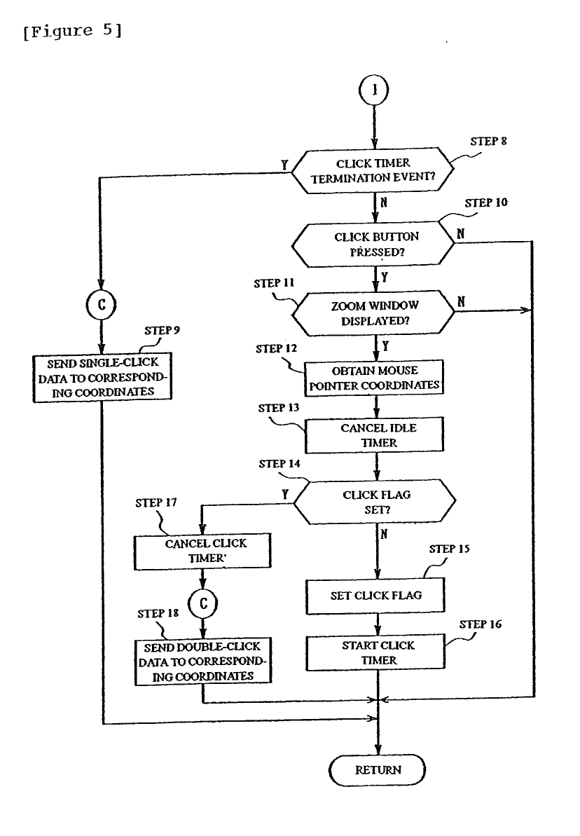

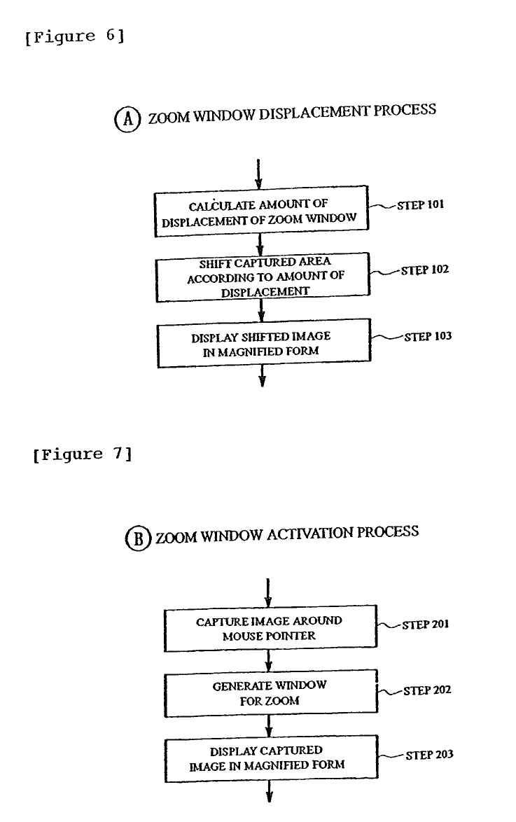

An operation on a zoom window will be described first. As shown in FIGS. 4 through 5, it is determined whether an operation for changing a zoom position has been performed (step 1). If it is determined at step 1 that the operation for displacing the zoom position has been performed, a zoom window displacement process shown in FIG. 6 is performed. That is, the amount of the displacement of the zoom window is calculated (step 101), a captured area is shifted according to the amount of the displacement (step 102), then the shifted image is displayed in magnified form (step 103), as shown in FIG. 6. Then the idle timer is canceled (step 2), the idle timer is started (step 3), then the process proceeds to “return”, as shown in FIGS. 4 through 5.

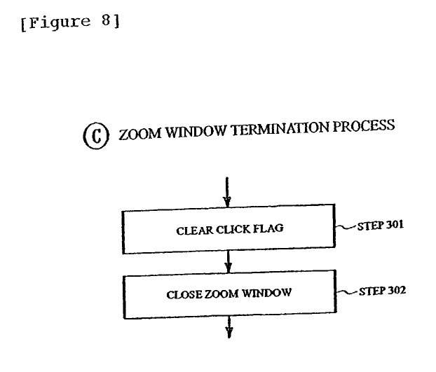

In another aspect of the present invention, if it is determined at step 1 that no zoom position displacement operation has been performed, it is determined whether an operation (which is a zoom-process-initiating action) for initiating a zoom (step 4) has been performed. If it is determined at step 4 that the zoom-initiating operation has been performed, a zoom window activation process shown in FIG. 7 is performed. That is, an image around the mouse pointer is captured (step 201), a window for the zoom is generated (step 202), then the captured image is displayed in magnified form, as shown in FIG. 7. Then the idle timer is started (step 3) and the process proceeds to “return” as shown in FIGS. 4 through 5.

If it is determined at step 4 that no operation for initiating a zoom is performed, it is determined whether an operation for terminating a zoom has been performed (step 5). If it is determined at step 5 that the zoom terminating operation has been performed, the idle timer is canceled (step 6) and a zoom window termination process shown in FIG. 8 is performed. That is, a click flag is cleared (step 301) and the zoom window is closed (step 302), as shown in FIG. 8. Then the process proceeds to “return” as shown in FIGS. 4 through 5.

If it is determined at step 5 that no operation for terminating a zoom has been performed, it is determined whether an idle timer termination event has occurred (step 7). If it is determined at step 7 that the idle timer termination event has occurred, the zoom window termination process shown in FIG. 8 is performed and the process proceeds to “return”. Up to this point the zoom window process has been described.

Next, a process for single-click and double click in a zoom window will be described below. In FIGS. 4 through 5, if it is determined at step 7 that no idle timer termination event has occurred, it is determined whether a click timer termination event has occurred (step 8). If it is determined at step 8 that a click timer termination event has occurred, the zoom window termination process described above with respect to FIG. 8 is performed. Then single-click data is provided to corresponding coordinates (step 9) and the process proceeds to return.

If it is determined at step 8 that no click timer termination event has occurred, it is determined whether a click button has been pressed or not (step 10). If it is determined at step 10 that the click button has not been pressed, the process proceeds to return. If it is determined at step 10 that the click button has been pressed, it is determined whether a zoom window is displayed (step 11).

If it is determined at step 11 that no zoom window is displayed, the process proceeds to return. If it is determined at step 11 that a zoom window is displayed, the coordinates of the mouse pointer are obtained (step 12), the idle timer is canceled (step 13), and it is determined whether a click flag is set (step 14).

If it is determined at step 14 that no click flag is set, a click flag is set (step 15), a click timer is started (step 16), and the process proceeds to return. If it is determined at step 14 that a click flag is set, the click timer is canceled (step 17), and the zoom window termination process described above with respect to FIG. 8 is performed. Then double-click data is provided to corresponding coordinates (step 18). Various application windows or icons may be placed at corresponding coordinates. The double-click data is eventually provided to an application associated with a window or an icon at the corresponding coordinates and various processes may be performed in response to the double-click at the corresponding coordinates. Then, the process proceeds to return. Up to this point the process for single-click and double click has been described.

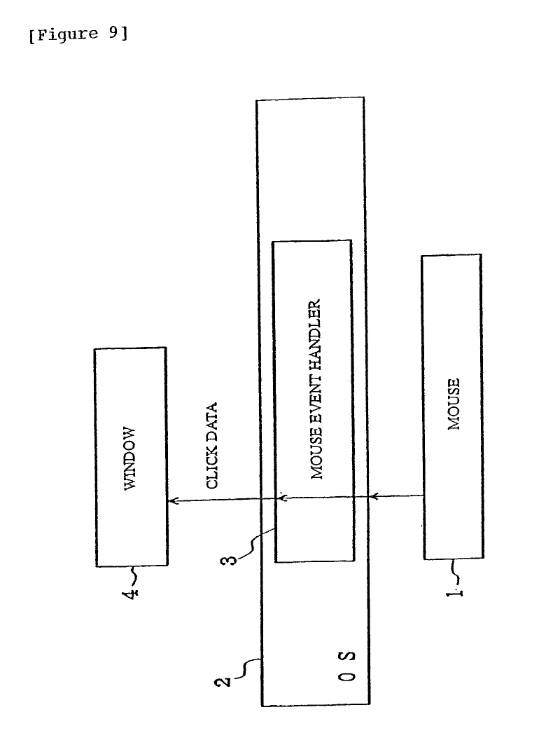

Next, the flow of click data when a click operation is performed in a zoom window will be described below. FIG. 9 is a block diagram of the flow of click data when no zoom window is activated. Click data input through a mouse 1 is provided through a mouse event handler 3 in an operating system 2 to the window 4 of an application at a position where a click operation is performed.

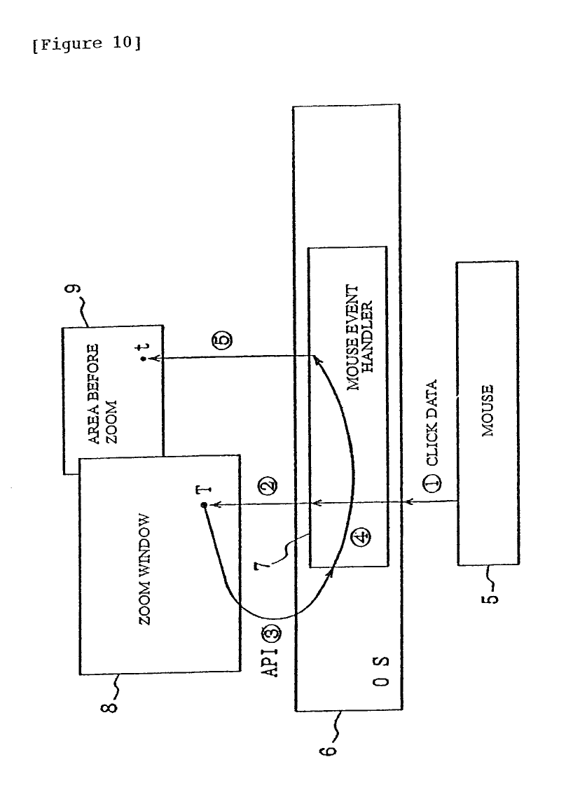

FIG. 10 is a block diagram of the flow of click data in the input event generating method according to the present invention. When a click operation is performed at point T in a zoom window 8 with a mouse 5, click data is provided from the mouse 5 to the zoom window 8 through a mouse event handler 7 of an operating system 6. Then the coordinates of point t in an area 9 before the zoom that corresponds to point T is calculated based on the data on the click at point T by the calculation method described earlier and the type of the mouse event is obtained. Then, the coordinates of point t and the type of the event are used to call the API (Application Program Interface) of the mouse event handler 7 and cause the mouse event handler 7 to generate click data to point t.

The API used here is one supported by the mouse event handler 7 and capable of generating click data for specified coordinates. The receiver of the click data treats click data generated by the API and click data generated by the mouse 5 equally. That is, the click data can be treated as if a button of the mouse 5 were clicked at point t even if no input is actually performed through the mouse 5. Therefore if the window of an application is at the poison of point t, data on a click at point t is provided to the application as with the process shown in FIG. 9. Thus, the same effect can be achieved as that of a mouse click performed on the application with the mouse 5.

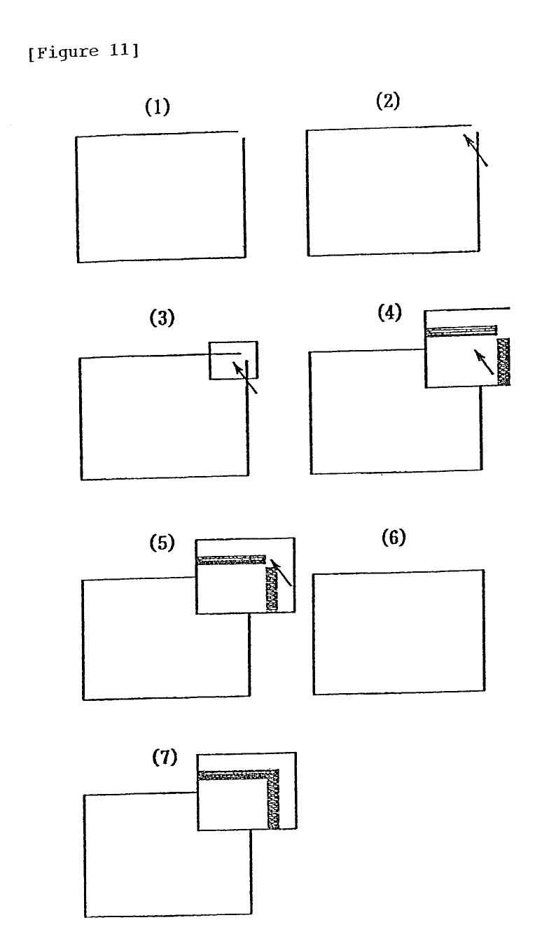

FIG. 11 is a diagram for illustrating a specific example of operations in the input event generating method according to the present invention. In the example shown in FIG. 11, the present invention is used to fill in a break at the upper right corner of a drawing of a rectangle. The operation is performed through the following steps. Numbers in the following description correspond to numbers in FIG. 11.

(1) A drawing of a rectangle, one dot at the upper right corner of which is missing, is shown. It is difficult to place a mouse pointer exactly on the missing part in this state.

(2) The mouse pointer is positioned near the upper right corner of the rectangle. This is easy because it is not required that the mouse pointer is placed exactly at the upper right corner.

(3) When a zoom button is pressed, an image of an area (within a box in the figure) around the mouse pointer is captured.

(4) A window centered on the mouse pointer is generated and the captured image is zoomed up and displayed in it.

(5) The mouse pointer is placed on the upper right corner of the zoomed rectangle in the zoom window and a click operation is performed on it.

(6) The zoom window disappears and click data is provided to the upper right corner of the rectangle in the original drawing.

(7) When the upper right corner of the rectangle is magnified, it can be seen that the upper right corner of the rectangle at which one dot was missing is now filled in.

Another preferred embodiment of the present invention is configured in such a way that a zoom window is moved by an operation for moving a mouse pointer while pressing a zoom button and an image in the zoom window is also changed in response to the motion of the mouse pointer. In this configuration, the position of the zoom window can be shifted easily. In addition, scaling factors and resizing options from which a user can select a desired scaling factor or size can be displayed by the user pressing the left or right mouse button while pressing the zoom button, and the shape of the zoom window can be changed by a dragging operation or other operations to provide the optimum usability for the user working in the zoom window according to the circumstances. Thus, the user's working efficiency can be significantly improved.

Furthermore, the usability of an information terminal such as a desktop personal computer and notebook personal computer can advantageously be improved by including the above-described zooming method of the present invention in the terminal.

As is apparent from the forgoing description, a magnified view of an image around a mouse pointer is displayed at a position where a mouse pointer is placed when a process-initiating action, in particular a press of a zoom button, is performed, in particular, according to the present invention, therefore the user can easily and correctly select a small object on the display screen with the mouse pointer. In addition, a required minimum area can be zoomed without changing the placement of windows by using the zoom window, thereby allowing a more seamless operation. Because the process can be performed on a coordinate-by-coordinate basis, each individual pixel in the zoom window can be selected with the mouse pointer and, for example, painted.

What is claimed is:

1. A method of generating an input event in an image display system including a display device and a pointing device for pointing an image displayed on the display screen of said display device with a pointer, comprising the steps of:
displaying a zoom window in which a given area in said display screen is displayed in magnified form, in response to a process-initiating action; and,
generating an input event associated with an pointing device operation at second coordinates corresponding to said first coordinates in said given area, when an operation of said pointing device is detected at first coordinates in said zoom window.

2. The method according to claim 1, wherein said process-initiating action is a press of a zoom button assigned to a predetermined button or key.

3. The method according to claim 1, wherein said given area is a rectangular area around a mouse pointer at which a process-initiating action is detected.

4. The method according to claim 1, wherein said zoom window is closed after no operation is performed on said zoom window for a predetermined time period.

5. The method according to claim 2, wherein said zoom window is closed when said zoom button is pressed while said zoom window is displayed.

6. The method according to claim 2, wherein said zoom window is moved by an operation for moving a mouse pointer while said zoom button is pressed.

7. The method according to claim 1, wherein a scaling factor and display shape of said zoom window can be changed.

8. An information terminal apparatus configured to allow an input event generating method to be performed on a screen of a display, wherein said generating comprising the steps of:
displaying a zoom window in which a given area in said display screen is displayed in magnified form, in response to a process-initiating action; and,
generating an input event associated with an pointing device operation at second coordinates corresponding to said first coordinates in said given area, when an operation of said pointing device is detected at first coordinates in said zoom window.

9. The apparatus of claim 8, wherein said process-initiating action is a press of a zoom button assigned to a predetermined button or key.

10. The apparatus of claim 8, wherein said given area is a rectangular area around a mouse pointer at which a process-initiating action is detected.

11. The apparatus of claim 8, wherein said zoom window is closed after no operation is performed on said zoom window for a predetermined time period.

12. The apparatus of claim 8, wherein said zoom window is closed when said zoom button is pressed while said zoom window is displayed.

13. The apparatus of claim 8, wherein said zoom window is moved by an operation for moving a mouse pointer while said zoom button is pressed.

14. The apparatus of claim 8, wherein a scaling factor and display shape of said zoom window can be changed.

15. A computer performing an input event generating method on a display screen, wherein said method comprising the steps of:
displaying a zoom window in which a geometric area in said display screen is displayed in magnified form, in response to a zoom feature being activated; and,
generating an input event associated with an pointing device operation at second coordinates corresponding to said first coordinates in said geometric area, when an operation of said pointing device is detected at first coordinates in said zoom window.

16. The computer of claim 15, wherein said zoom window is closed after no operation is performed on said zoom window for a predetermined time period.

17. The computer of claim 15, wherein said zoom window is closed when said zoom button is pressed while said zoom window is displayed.

18. The apparatus of claim 15, wherein said zoom window is moved by an operation for moving a mouse pointer while said zoom button is pressed.

19. The apparatus of claim 15, wherein a scaling factor and display shape of said zoom window can be changed.
